(19) United States
(12) Patent Application Publication
(10) Pub. No.: US 2013/0164480 A1
(43) Pub. Date: Jun. 27, 2013

(54) ELASTIC LAMINATE SHEET

(71) Applicants: Hiroshi Sakurai, Kanagawa (JP); Takeshi Yamada, Kanagawa (JP); Hirofumi Hosokawa, Tokyo (JP)

(72) Inventors: Hiroshi Sakurai, Kanagawa (JP); Takeshi Yamada, Kanagawa (JP); Hirofumi Hosokawa, Tokyo (JP)

(73) Assignee: 3M INNOVATIVE PROPERTIES COMPANY, ST. PAUL, MN (US)

(21) Appl. No.: 13/819,984

(22) PCT Filed: Aug. 22, 2011
(86) PCT No.: PCT/US11/48607

§ 371 Date: Feb. 28, 2013

(30) Foreign Application Priority Data
Sep. 2, 2010 (JP) 2010-197176

(51) Int. Cl. B32B 3/16

(52) U.S. Cl. CPC B32B 3/16
USPC 428/56

(57) ABSTRACT

An elastic laminate sheet comprising a laminate comprising an elastomer layer and a nonwoven fabric provided on at least one surface of the elastomer layer, wherein low elastic laminate part and high elastic laminate part are alternatingly provided in one direction to form the laminate, and the low elastic laminate part and the high elastic laminate part both have a first bonding region where the elastomer layer and the nonwoven fabric are bonded and a second bonding region where the elastomer and the nonwoven fabric are bonded more weakly than at the first bonding region, and a total surface area of the first bonding region in the low elastic laminate part is larger than a total surface area of the first bonding region in the high elastic laminate part, and a ratio of an elastic modulus of the low elastic laminate part to an elastic modulus of the high elastic laminate part is more than 1 and not more than 7.5. The elastic laminate sheet does not easily break even when repeatedly stretched and demonstrates sufficient retention capacity for practical use even when attached to a main body part of a hygienic article or the like.

### TECHNICAL FIELD

The present invention relates to an elastic laminate sheet.

### BACKGROUND ART

Various elastic members have been proposed for use in diapers and other hygiene products. Japanese Patent Publication No. H7-252762A, Japanese Patent Publication No. 2007-230180A, Japanese Patent Publication No. 2009-132081A and Japanese Patent Publication No. 2003-520146A each disclose multilayer elastic members made by laminating a layer containing an elastomer with a nonwoven fabric.

### SUMMARY OF THE INVENTION

A conventional elastic member can develop cracks when repeatedly used in certain structures, and there are cases where further improvements to durability are required. Furthermore, elastic members are required to be sufficiently retained when attached to a main body part of hygienic products and the like.

The present invention is an elastic laminate sheet comprising a laminate comprising an elastomer layer and a nonwoven fabric provided on at least one surface of the elastomer layer, wherein a low elastic laminate part and a high elastic laminate part are alternatingly provided in one direction to form the laminate, and the low elastic laminate part and the high elastic laminate part both have a first bonding region where the elastomer layer and the nonwoven fabric are bonded and a second bonding region where the elastomer and the nonwoven fabric are bonded more weakly than at the first bonding region, and a total surface area of the first bonding region in the low elastic laminate part is larger than a total surface area of the first bonding region in the high elastic laminate part, and a ratio of an elastic modulus of the low elastic laminate part to an elastic modulus of the high elastic laminate part is more than 1 and not more than 7.5.

Furthermore, the elastic laminate sheet of the present invention may be composed of a laminate containing an elastomer layer and a nonwoven fabric provided on both surfaces of the elastomer layer.

Furthermore, the present invention provides an article containing the aforementioned elastic laminate sheet.

The elastic laminate sheet is provided that does not easily break even when repeatedly stretched and has a level of retention to a main body part sufficient for practical use even when attached to a main body part of a hygienic article or the like.

### BRIEF DESCRIPTION OF DRAWINGS

FIG. 1 is a perspective view of an elastic laminate sheet according to a first embodiment of the present invention;

FIG. 2 is (a) a top view and (b) a cross-section view along the section line I-I, of an elastic laminate sheet according to the first embodiment of the present invention;

FIG. 3 is a perspective view of an elastic laminate sheet according to a second embodiment of the present invention;

FIG. 4 is (a) a top view and (b) a cross-section view along the section line III-III, of an elastic laminate sheet according to a second embodiment of the present invention;

FIG. 5 is (a) a top view and (b) a cross-section of an elastic laminate sheet according to a third embodiment of the present invention;

FIG. 6 is (a) a top view and (b) a cross-section of an elastic laminate sheet according to a fourth embodiment of the present invention;

FIG. 7 is (a) a top view and (b) a cross-section of an elastic laminate sheet according to a fifth embodiment of the present invention;

FIG. 8 is (a) a top view and (b) a cross-section of an elastic laminate sheet according to a sixth embodiment of the present invention;

FIG. 9 is an example of a manufacturing method for the elastic laminate sheet according to the present embodiments; and

FIG. 10 is (a) a top view and (b) a cross-section view of a conventional elastic laminate sheet.

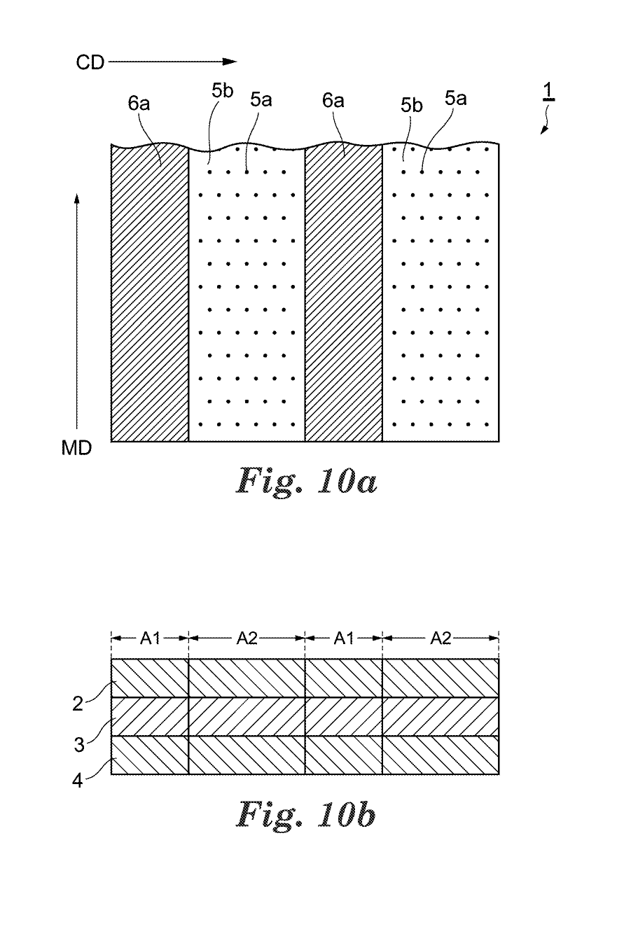

### DETAILED DESCRIPTION OF THE INVENTION

Preferred embodiments of the present invention are described below in detail while referring to the drawings, but the elastic laminate sheet of the present invention is not limited to the following embodiments. Note that in the following descriptions, identical or similar parts are assigned the same reference numerals and a duplicate description is omitted.

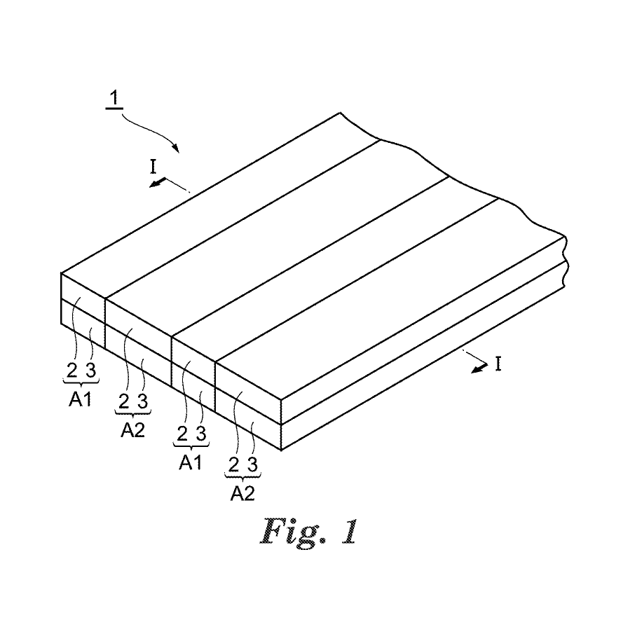

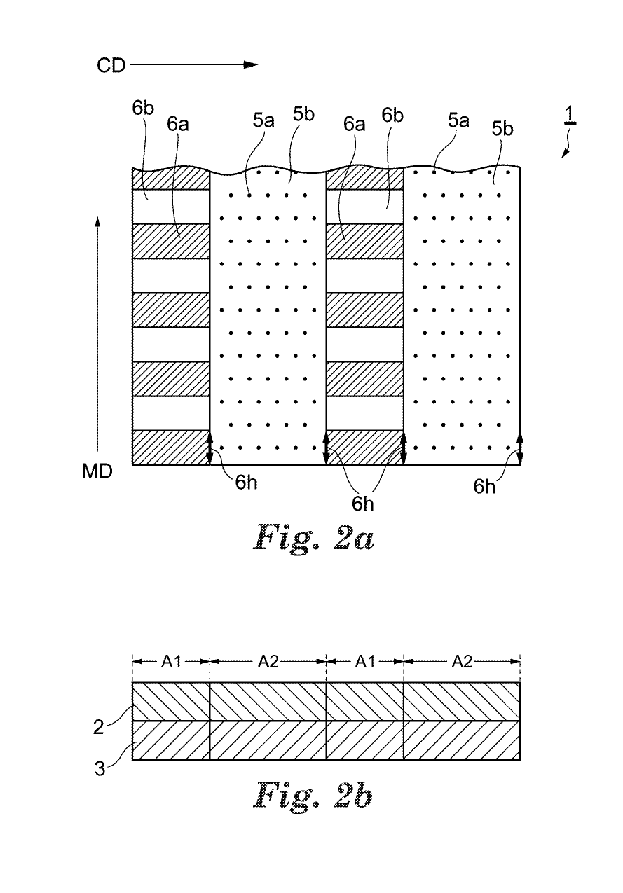

FIG. 1 is a perspective view of an elastic laminate sheet according to the first embodiment, and FIG. 2 is (a) a top view and (b) a cross-section view along section line I-I of the elastic laminate sheet according to the first embodiment. The elastic laminate sheet according to the first embodiment shown in FIG. 1 and FIG. 2 is composed of a laminate containing an elastomer layer 3 and a nonwoven fabric 2 provided on at least one surface of the elastomer layer 3. Furthermore, the elastic laminate sheet 1 has a low elastic laminate part A1 and a high elastic laminate part A2 that form the aforementioned laminate, and the low elastic laminate part A1 and the high elastic laminate part A2 are arranged alternatingly in one direction.

For example, if the high elastic laminate part A2 and the low elastic laminate part A1 are formed as strip regions parallel to the direction of flow of the sheet when the sheet is manufactured (MD: Machine Direction), then the high elastic laminate part A2 and the low elastic laminate part A1 will be adjacent in the lateral direction perpendicular to the MD (CD: Cross Machine Direction). Furthermore, if the high elastic laminate part A2 and the low elastic laminate part A1 are formed as strip regions parallel to the direction (CD) perpendicular to the direction of flow (MD) of the sheet when the sheet is manufactured, the high elastic laminate part A2 and the low elastic laminate part A1 will be adjacent along the MD.

As shown in FIG. 2, the low elastic laminate part A1 and the high elastic laminate part A2 each have first bonding regions 6a, 5a that join the elastomer layer 3 and the nonwoven fabric 2, and second bonding regions 5b, 6b that join the elastomer layer 3 and the nonwoven fabric 2 more weakly than the first bonding regions 5a, 6a. In other words, the low elastic laminate part A1 has first bonding regions 6a and second bonding regions 6b, and the elastomer layer 3 and the nonwoven fabric 2 are more strongly bonded in the former regions. Similarly, the high elastic laminate part A2 has first bonding regions 5a and second bonding regions 5b, and the elastomer layer 3 and the nonwoven fabric 2 are more strongly bonded in the former regions. Herein, the bonding strength per unit area in the first bonding regions 5a, 6a can be the same or different, so long as the low elastic laminate part A1 has lower elasticity than the high elastic laminate part A2. Also, the bonding strength per unit area of the first bonding regions 5a, 6a is stronger than the bonding strength per unit area of the second bonding regions 5b, 6b, respectively. Furthermore, the bonding strength per unit area of the second bonding regions 5b, 6b can be the same or different, so long as the low elastic laminate part A1 has lower elasticity than the high elastic laminate part A2. Furthermore, the total area of the first bonding regions 6a in the low elastic laminate part A1 is larger than the total area of the first bonding regions 5a in the high elastic laminate part A2.

The ratio of the elastic modulus of the low elastic laminate part A1 to the elastic modulus of the high elastic laminate part A2 ([elastic modulus of low elastic laminate part A1]/[elastic modulus of high elastic laminate part A2]) is more than 1 and not more than 7.5. If the ratio of the elastic modulus of the low elastic laminate part A1 to the elastic modulus of the high elastic laminate part A2 is a value within the aforementioned range, then, with respect to the elastic laminate sheet 1 or an elastic member cut to a predetermined size and shape from the elastic laminate sheet 1, the low elastic laminate part A1 can be sufficiently retained for practical use on a main body part (hereinafter also referred to as “retention”) when the low elastic laminate part A1 are used as a fastening parts to the main body part of another hygienic article or the like. Furthermore, if the ratio of the elastic modulus of the low elastic laminate part A1 to the elastic modulus of the high elastic laminate part A2 is a value within the aforementioned range, breaking can be reduced near the interface between the high elastic laminate part A2 and the low elastic laminate part A1 when stretching is repeatedly performed. The upper limit of the ratio of the elastic modulus of the low elastic laminate part A1 to the elastic modulus of the high elastic laminate part A2 is preferably not more than 7.0, from a perspective of more effectively achieving the aforementioned effects. Note, the “low elastic laminate part” has an elasticity that is typically 10 mPa or higher.

The elastic modulus of the low elastic laminate part A1 and the elastic modulus of the high elastic laminate part A2 can be measured using a tensile tester. For example, the elastic modulus of the low elastic laminate part A1 can be measured by the following method. First, a narrow strip test sample 10 mm wide in the longitudinal direction (MD) and 20 mm long in the lateral direction (CD) is cut from the low elastic laminate part A1 of the elastic laminate sheet. Next, the test sample obtained is fastened to a tensile tester (model RTG-1225 manufactured by Orientec Co., Ltd.) such that the distance between chucks is 15 mm without tension and the CD direction of the test sample is in the direction of tension. The test sample is deformed at a rate of 100 mm/minute in the CD direction and the stress strain curve is determined. The elastic modulus is determined from the slope of the section of the stress strain curve obtained where the stress rises in a straight line. Note, the elastic modulus of the high elastic laminate part A2 can be measured similarly.

Note, the elasticity of the low elastic laminate part and the high elastic laminate part is dependent on the bonding strength of the elastomer layer 3 and the nonwoven fabric 2, the materials making up the elastomer layer 3 and the nonwoven fabric 2, and the thickness of the elastomer layer 3 and the nonwoven fabric 2, and the elasticity of the entire elastic laminate sheet is dependent on the relative abundance of the low elastic laminate part and high elastic laminate part, in addition to the above.

The shape of the elastic laminate sheet 1 is arbitrary and any shape such as a rectangle, circle, or the like is acceptable. For the case of a rectangular shape, for example, the ratio of the width of the low elastic laminate part A1 to the width of the high elastic laminate part A2 ([width of low elastic laminate part A1]/[width of high elastic laminate part A2]) is generally between 0.05 and 10. Furthermore, in one aspect, the ratio of the width of the low elastic laminate part A1 to the width of the high elastic laminate part A2 can be between 0.1 and 5. Therefore, an elastic laminate sheet with excellent elasticity, durability, and retention can be obtained.

First, the elastomer layer 3 included in the elastic laminate sheet 1 is described. The elastomer layer 3 is not particularly restricted, so long as the elastomer layer 3 has elasticity and shows adhesion when melted by heating. As the raw material of the elastomer layer 3, a composition that contains a styrene-isoprene-styrene copolymer (hereinafter referred to as “SIS copolymer”), for example, can be used, in addition to additives such as a tackifier (adhesion enhancing agent) and the like.

From the perspective of durability of the elastomers layer 3, the SIS copolymer accounts for 96 mass %, or more of the mass thereof, based on the total amount of raw material composition of the elastomer layer 3.

From the perspective of film strength and elastic flexibility, the content of styrene in the SIS copolymer is preferably between 15 and 45%.

The melted flow rate of the SIS copolymer (200° C., 5.0 kg) is preferably higher from viewpoints of fluidity (workability) and film stability when the elastomer composition is made into a layer, and in one aspect, the melted flow rate can be in a range between 10 and 45. Furthermore, in another aspect, the lower limit of the melted flow rate of the SIS copolymer can be 20, and the upper limit can be 40.

The SIS copolymer can be either a nonmodified type or a modified type. A modified SIS copolymer can be obtained by the addition reaction (for example, a graft reaction) of an unsaturated carboxylic acid or derivative thereof onto a SIS copolymer. Specific examples include maleic acid, fumaric acid, itaconic acid, acrylic acid, crotonic acid, endo-bicyclo[2,2,1]-5-heptene-2,3-dicarboxylic acid, and cis-4-cyclohexene-1,2-dicarboxylic acid, as well as anhydrides and imido compounds thereof. Furthermore, an SIS copolymer with a backbone having three or more branches can be used, and two or more types of SIS copolymers can be used in combination. Examples include commercial products such as Kraton D1114P, Kraton D1117P (products of Kraton Polymer Japan), and Vector 4111 (product of Dexco Polymer LP).

The raw material composition of the elastomer layer 3 can be a blend of SIS copolymer and a polyurethane elastomer. In this case, the polyurethane elastomer content is preferably between 75 and 99.9 mass %, based on the total amount of SIS copolymer and polyurethane elastomer.

The polyurethane elastomer has a urethane bond in the molecule, and can be obtained by a polyaddition reaction between a polyol component containing long chain polyols and short chain polyols, and an isocyanate such as a diisocyanate. The polyol that is used can be a polyester type, adipate type, polyether type, or polycaprolactone type polyol.

Examples of long chain polyols include polyether diols (such as poly(oxytetramethylene) glycol and poly(oxypropylene) glycol) and polyester diols (such as poly(ethylene adipate) glycol, poly(1,4-butylene adipate) glycol, poly(1,6-hexylene adipate) glycol, poly(hexandiol-1,6-carbonate) glycol), and the like. Examples of short chain polyols include ethylene glycol, 1,3-propylene glycol, bisphenol A, 1,4-butanediol, 1,4-hexanediol, and the like.

Examples of the diisocyanate include 4,4′-diphenylmethane diisocyanate, toluene diisocyanate, hexamethylene diisocyanate, and the like.

The Shore A hardness (JIS A hardness) of the polyurethane elastomer can be between, for example, 60 and 95. If the Shore A hardness (JIS A hardness) of the polyurethane elastomer is between 60 and 95, the film stability can be increased when the raw material composition of the elastomer layer 3 is melted and a film is formed, and a film with good elastic flexibility can be achieved. Furthermore, two or more types of polyurethane elastomers can be used in combination.

For example, commercially available polyurethane elastomers can include PANDEX™ T-1575N (product of DIC Bayer Polymer Ltd.), Elastollan™ ET-680 (product of BASF Japan Ltd.), Miractran™ E675 (product of Nippon Polyurethane Industry Co. Ltd.), and the like.

The tackifier preferably has favorable compatibility with the SIS copolymer. The material that is used can be rosin-based, terpene-based, petroleum-based, or the like. Two or more types of tackifiers can also be used in combination.

For example, commercial products that can be used include Pine Crystal™ (product of Arakawa Chemical Industries, Ltd.) as a rosin type tackifier; YS Polystar™ (product of Yasuhara Chemical) as a terpene type tackifier; and petroleum type tackifiers such as Wingtack Plus™ (product of Cray Valley Co., Ltd.), Arcon™ (product of Arakawa Chemical Industries, Ltd.), and the like.

The amount of tackifier is preferably between 0.1 and 10 mass %, based on the total amount of raw material composition of the elastomer layer 3. If a tackifier is added to the raw material composition within the aforementioned ranges, the productivity when manufacturing the elastomer layer and the durability of the layer obtained will be improved.

The raw material composition of the elastomer layer 3 can also contain various other additives (such as antioxidants, weathering agents, UV absorbers, colorants, inorganic fillers, oils, and the like).

The thickness of the elastomer layer 3 can be between approximately 5 and 100 μm, and either a single layer construction or a multilayer construction is acceptable. For the case of a multilayer construction, each of the layers may be constructed from a different elastomer composition.

The nonwoven fabric 2 included in the elastic laminate sheet 1 is now described. The fiber material that forms the nonwoven fabric 2 is not particularly restricted, and can be made from various types of fiber materials that are conventionally known. From the perspective of the elasticity and strength of the elastic laminate sheet 1, a fiber blend of polyester fibers and polyolefin fibers is preferable. The fiber blend ratio is not particularly restricted, but a blend that contains primarily polyester fibers that are blended with polyolefin fibers is preferable from perspectives of elasticity and strength.

The manufacturing method for the nonwoven fabric is not restricted. The nonwoven fabric can be manufactured from the aforementioned materials using a conventionally known manufacturing method. A spunbond method, a spunlace method, a thermal bond method, or the like are preferable from the perspective of providing favorable elasticity to the elastic laminate sheet 1. The spunlace method can provide a favorable feel to the nonwoven fabric obtained.

The thickness of the nonwoven fabric 2 can be between approximately 30 μm and 1 mm. Furthermore, the nonwoven fabric can generally have a mass per unit area between approximately 15 and 50 gsm. Note, the thickness of the entire elastic laminate 1 can vary across a wide range depending on the application, but is generally within a range between approximately 50 μm and 2 mm. Note, the thickness of the low elastic laminate part A1 and the thickness of the high elastic laminate part A2 are not necessarily required to be equal, and the average value for the thickness of both parts should be within the aforementioned range. Furthermore, if the elastic laminate sheet 1 is a laminate with nonwoven fabric 2, 4 on both sides of an elastomer layer 3, the nonwoven fabric 2 and the nonwoven fabric 4 can either be the same or different types of materials.

In the elastic laminate sheet 1 of the first embodiment, the shape of the first bonding regions 6a in the low elastic laminate part A1 is a strip shape in the CD (Cross Machine Direction) which is the direction perpendicular to the direction of flow of the elastic laminate sheet 1 (MD: Machine Direction). The strip shaped first bonding regions 6a are arranged along the MD at fixed intervals.

The longitudinal direction of the strip shaped first bonding regions 6a intersects the MD, and the angle between the longest axis of the axes of symmetry of the strip shaped first bonding regions 6a and the direction of orientation (MD) for the strip shaped high elastic laminate part A2 and the low elastic laminate part A1 is preferably higher than 0° but 90° or less, and more preferably between 10° and 90°, inclusively. The width of the strip shaped first bonding regions 6a and the interval between the strip shaped first bonding regions 6a are not particularly restricted, but the proportion of the low elastic laminate part A1 that the first bonding regions 6a occupy is preferably 85% or less, more preferably 70% or less, and particularly preferably 60% or less, from a perspective of crack resistance (durability) between the low elastic laminate part A1 and the high elastic laminate part A2. In the strip shaped first bonding regions 6a, if the length 6h of the strip in the MD is short, there will be a tendency for the crack resistance (durability) at the interface between the low elastic laminate part A1 and the high elastic laminate part A2 to increase.

On the other hand, from a perspective of retention, the proportion is preferably 2% or more, more preferably 5% or more, and particularly preferably 10% or more.

The shape of the first bonding regions 5a of the high elastic laminate part A2 is not particularly restricted, and for example, a dot shape with an area that is smaller than the area of the shape of the first bonding regions 6a formed in the low elastic laminate part A1 is preferable. Furthermore, in the high elastic laminate part A2, the first bonding regions 5a are preferably evenly dispersed.

From the perspective of increasing the crack resistance (durability) between the low elastic laminate part A1 and the high elastic laminate part A2 while maintaining the retention of the elastic members, the ratio of the area that the first bonding regions 6a occupy to the total area of the low elastic laminate part A1 is preferably 10% or higher and 70% or less, and the ratio of the area that the first bonding regions 5a occupy to the total area of the high elastic laminate part A2 is preferably 0.4% or higher and less than 10%.

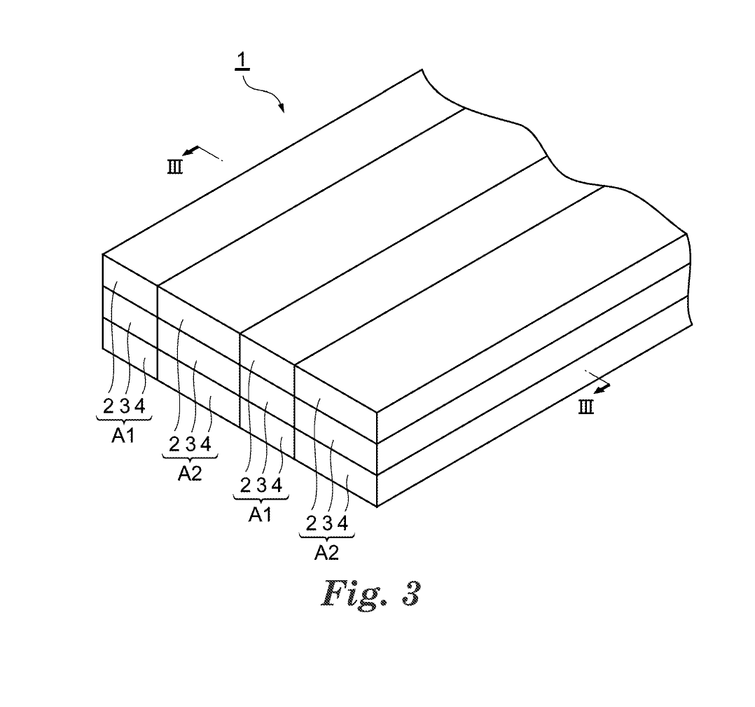

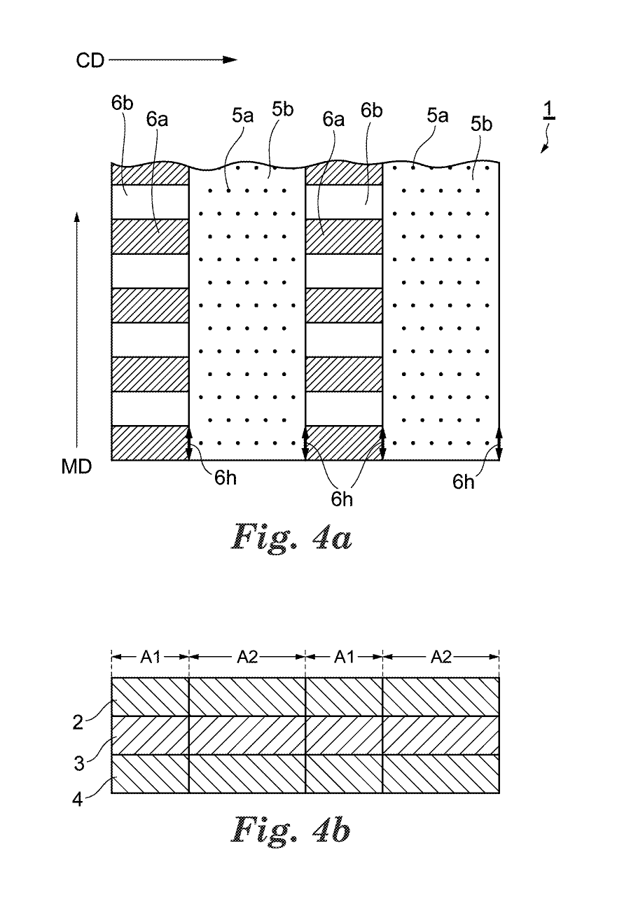

FIG. 3 is a perspective view of an elastic laminate sheet according to the second embodiment, and FIG. 4 is (a) a top view and (b) a cross-section view along section line III-III of the elastic laminate sheet according to the second embodiment. The elastic laminate sheet 1 according to the second embodiment shown in FIG. 3 and FIG. 4 is made from a laminate containing an elastomer layer 3 and nonwoven fabrics 2 and 4 provided on both surfaces of the elastomer layer 3. Furthermore, the elastic laminate sheet 1 has low elastic laminate parts A1 and high elastic laminate parts A2 that form the laminate, and the low elastic laminate parts A1 and the high elastic laminate parts A2 are arranged alternatingly in one direction.

In the second embodiment as well, as shown in FIG. 4, the low elastic laminate part A1 and the high elastic laminate part A2 each has first bonding regions 6a, 5a that join the elastomer layer 3 and the nonwoven fabric 2 or 4, and second bonding regions 5b, 6b that join the elastomer layer 3 and the nonwoven fabric 2 or 4 more weakly than the first bonding regions 5a, 6a. In other words, the low elastic laminate part A1 has first bonding regions 6a and second bonding regions 6b, and the elastomer layer 3 and the nonwoven fabric 2 or 4 are more strongly bonded in the former regions. Similarly, the high elastic laminate part A2 has first bonding regions 5a and the second bonding regions 5b, and the elastomer layer 3 and the nonwoven fabric 2 or 4 are more strongly bonded in the former regions. Herein, the bonding strength per unit area in the first bonding regions 5a, 6a can be the same or different so long as the low elastic laminate part A1 has lower elasticity than the high elastic laminate part A2, and both are stronger than the bonding strength per unit area of the second bonding regions 5b, 6b. Furthermore, the bonding strength per unit area of the second bonding regions 5b, 6b can be the same or different so long as the low elastic laminate part A1 has lower elasticity than the high elastic laminate part A2. Furthermore, in the first bonding regions 5a, 6a, and the second bonding regions 5b, 6b, the bonding strength between the elastomer layer 3 and the nonwoven fabric 2 and the bonding strength between the elastomer layer 3 and the nonwoven fabric 4 can be equal or different, so long as the low elastic laminate part A1 have lower elasticity than the high elastic laminate part A2.

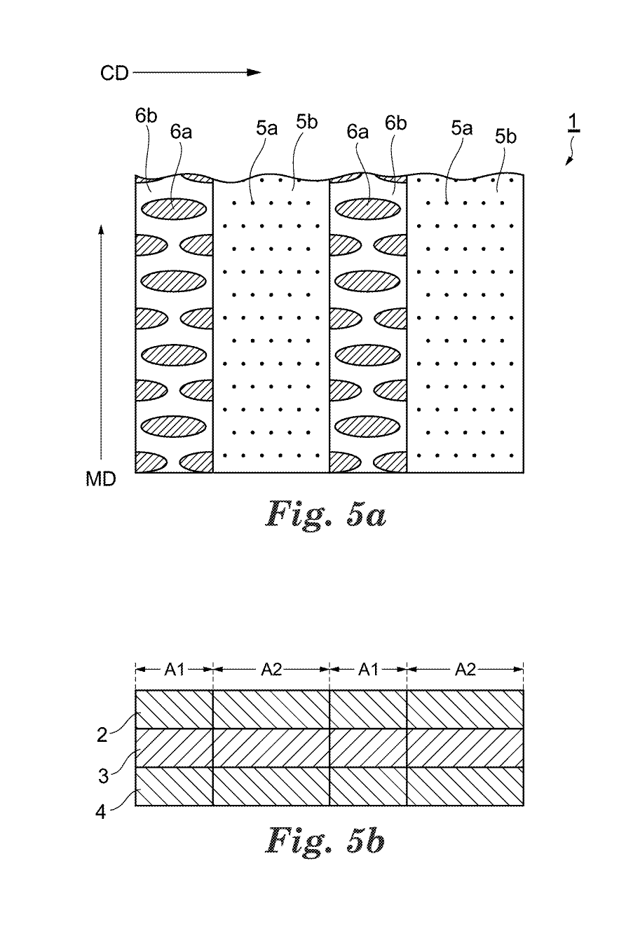

FIG. 5 is (a) a top view and (b) a cross-section of an elastic laminate sheet according to a third embodiment. In the third embodiment, the elastic laminate sheet 1 is made from a laminate containing an elastomer layer 3 and nonwoven fabrics 2 and 4 provided on both surfaces of the elastomer layer 3, and the shape of the first bonding regions 6a in the low elastic laminate part A1 is elliptical. The longitudinal direction of the first bonding regions 6a intersects the MD, and the angle between the major axis of the elliptical first bonding regions 6a and the direction of orientation of the strip shaped high elastic laminate part A2 and the low elastic laminate part A1 is preferably higher than 0° but 90° or less, and more preferably between 10° and 90°, inclusively.

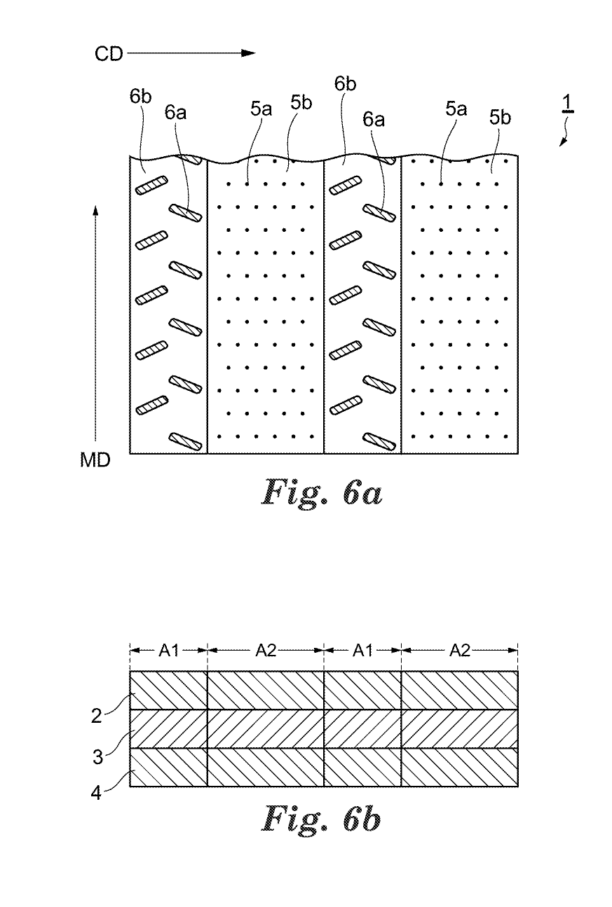

FIG. 6 is (a) a top view and (b) a cross-section of an elastic laminate sheet according to a fourth embodiment. In the fourth embodiment, the elastic laminate sheet 1 is made from a laminate containing an elastomer layer 3 and nonwoven fabrics 2 and 4 provided on both surfaces of the elastomer layer 3, and the first bonding regions 6a are shaped like elliptical rods rounded on both ends. The longitudinal direction of the first bonding regions 6a intersects the MD, and the angle between the longest axis of the axes of symmetry of the elliptical first bonding regions 6a and the direction of orientation for the strip shaped high elastic laminate part A2 and the low elastic laminate part A1 is preferably higher than 0° but 90° or less, and more preferably between 10° and 90°, inclusively. As shown in FIG. 4, the plurality of first bonding regions 6a can be provided such that the longitudinal directions thereof are at different directions with regards to the MD.

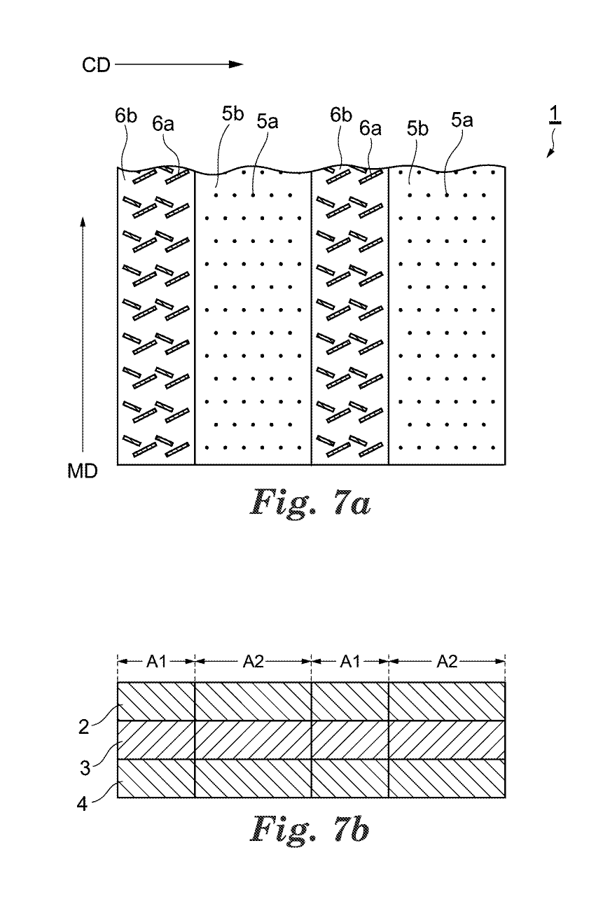

FIG. 7 is (a) a top view and (b) a cross-section of an elastic laminate sheet according to a fifth embodiment. In the fifth embodiment, the elastic laminate sheet 1 is made from a laminate containing an elastomer 3 and nonwoven fabrics 2 and 4 provided on both surfaces of the elastomer layer, and the shape of the first bonding regions 6a in the low elastic laminate part A1 is rod shaped. The longitudinal direction of the first bonding regions 6a intersects the MD, and the angle between the longest axis of the axes of symmetry of the elliptical rod shaped first bonding regions 6a and the direction of orientation for the strip shaped high elastic laminate part A2 and the low elastic laminate part A1 is preferably higher than 0° but 90° or less, and more preferably between 10° and 90°, inclusively. The first bonding region 6a of the low elastic laminate part A1 can be formed more concentrated than the first through fourth embodiments, due to the rod shape of the first bonding regions 6a.

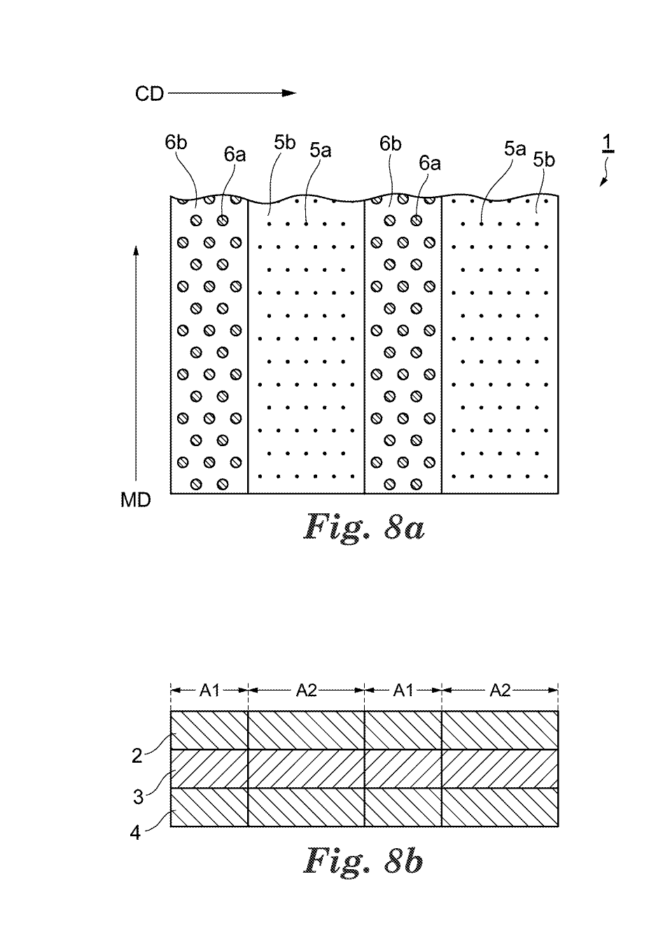

FIG. 8 is (a) a top view and (b) a cross-section of an elastic laminate sheet according to a sixth embodiment. In the sixth embodiment, the elastic laminate sheet 1 is made from a laminate containing an elastomer 3 and nonwoven fabrics 2 and 4 provided on both surfaces of the elastomer layer, and the shape of the first bonding regions 6a in the low elastic laminate part A1 is dot shaped.

The elastic laminate sheets of the first through sixth embodiments are described above, but the present invention is not restricted to these embodiments. For example, in the low elastic laminate part A1, the first bonding regions 6a are not necessarily composed of only one type of shape, and a mixture of strip shapes, elliptical shapes, elliptical rod shapes, rod shapes, and dot shapes can be used. Furthermore, in the high elastic laminate part A2, the first bonding regions 6a are not necessarily composed of only one type of shape, and a combination of elliptical shapes, elliptical rod shapes, rod shapes, and the like can be used in addition to the aforementioned dot shapes, so long as the elasticity is higher than that of the low elastic laminate part A1. It may be hypothesized that the crack resistance between the low elastic laminate part A1 and the high elastic laminate part A2 can be increased by controlling the dispersion condition of both the first bonding regions 6a in the low elastic laminate part A1 and the first bonding regions 5a in the high elastic laminate part A2.

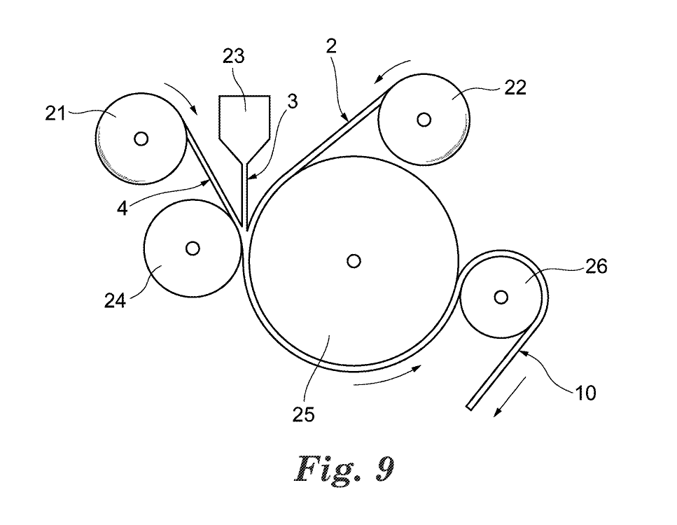

Herein, the manufacturing method of an elastic laminate sheet 1 having a structure that provides nonwoven fabrics 2, 4 on both surfaces of the elastomer layer 3 is described; in other words, an example of a laminate with a three layer structure, including a first nonwoven fabric 4, elastomer layer 3, and second nonwoven fabric 2, is described while referring to FIG. 9.

The elastic laminate sheet 1 can be constructed by separately constructing an elastomer layer and the nonwoven fabrics, and then performing a laminating process. Furthermore, the elastic laminate can also be constructed by integrally forming an elastomer layer and the nonwoven fabrics using a simultaneous melt extrusion lamination method. Either a laminate with a two layer construction containing an elastomer layer 3 and a nonwoven fabric 2 or a laminate with a three layer construction containing a first nonwoven fabric 4, an elastomer layer 3, and a second nonwoven fabric 2 can be manufactured by the simultaneous melt extrusion lamination method.

The simultaneous melt extrusion lamination method has various processes, but for example, the elastic laminate sheet 1 can be manufactured by a series of processes as shown in FIG. 9. The first nonwoven fabric 4 is unrolled from a supply roll 21, and is fed between a pair of lamination rollers 24, 25 as shown by the arrow. On the other hand, the second nonwoven fabric 2 is unrolled from a supply roller 22, and is fed between a cooling roller 25 and a nip roller 24 as shown by the arrow. Either or both of the cooling roller 25 and the nip roller 24 can be a calender roller or a rubber roller with a protruding pattern (a roller without a protruding pattern has an essentially flat surface). The elastomer layer 3 is fed in the form of melted flow from a die (normally a T-die) 23 that is connected to an extruder (not shown in the drawings), and is fed between the first nonwoven fabric 4 and the second nonwoven fabric 2, where the layer is cooled and hardened. Note, if the elastomer layer 3 has a multilayer construction, the melted flow of the elastomer layer 3 can be fed in the form of multilayered melted flow from a die 23 using two or more extruders.

The first nonwoven fabric 4, the elastomer layer 3, and the second nonwoven fabric 2 are laminated and integrated by the cooling roller 25 and the nip roller 24, as shown in the drawings. The sheet-like laminate obtained receives a tensile force from a tension roller 26, so it is fed in the direction of the arrow along the outer circumference of the cooling roller 25. The elastic laminate sheet 10 manufactured in this manner is made to change directions at the tension roller 26, and is then fed in the direction shown by the arrow and wound on a take-up reel (not shown in the drawings).

The elastic laminate sheet 10 obtained in this manner can be manufactured by simultaneously performing an elastomer film forming process and a process of laminating the elastomer film with a first nonwoven fabric and a second nonwoven fabric, and therefore has excellent cost performance.

Note, if the elastic laminate sheet 1, 10 is manufactured by a method of simultaneous melt extrusion and then laminating as described above, then the elastic laminate sheet 1, 10 is formed with bonding parts between the elastomer layer 3 and the nonwoven fabrics 2, 4 which have the aforementioned prescribed shape and are parts that bond relatively strongly (first bonding regions 5a and 6a) and parts that relatively weakly bond the elastomer layer 3 and the nonwoven fabrics 2, 4 (second bonding regions 5b and 6b), in the high elastic laminate part A2 and low elastic laminate part A1. Means thereof can be a method whereby a laminate is formed by sandwiching melted flow of the elastomer composition (melted polymer) extruded from a T-die using a melting extruder between a first and second nonwoven fabric, and then pressing (nipping) this laminate with a protruding pattern having a prescribed shape formed on one or both of a cooling roller 25 and a nip roller 24, and then cooling and hardening the melted polymer.

The shapes making up the protruding pattern provided on the parts that become the low elastic laminate part A1 can be strip shapes, elliptical shapes, elliptical rod shapes, rod shapes, dot shapes, or the like. In the region of the low elastic laminate part A1, the region that is nipped by the protruding pattern parts has the nonwoven fabric and the elastomer film more strongly bonded than the region that is nipped by the parts where the protruding pattern is not formed, and thereby the first bonding region 6a is formed.

Furthermore, the shape of the protruding pattern provided on the parts that become the high elastic laminate part A2 can have, for example, a dot shape or the like. Similar to the low elastic laminate part A1, in the region of the high elastic laminate part A2, the region that is nipped by the protruding pattern parts has the nonwoven fabric and the elastomer film more strongly bonded than the region that is nipped by the parts where the protruding pattern is not formed, and thereby the first bonding region 5a is formed.

Note that, for a nip roller, if the high elastic laminate part A2 and the low elastic laminate part A1 are formed as strip shaped regions parallel to the direction of flow of the sheet when the sheet is manufactured (MD: Machine Direction), or if the high elastic laminate part A2 and the low elastic laminate part A1 are formed as strip shaped regions parallel to the direction (CD) perpendicular to the direction of flow (MD) of the sheet when the sheet is manufactured and the like, a protruding pattern for the parts corresponding to the low elastic laminate part A1 and a protruding pattern for the parts corresponding to the high elastic laminate part A2 can be formed on the roller surface based on the direction in which the high elastic laminate part A2 and low elastic laminate part A1 are formed.

The total area of the first bonding regions 6a in the low elastic laminate part A1 is nipped by a protruding pattern so as to be larger than the total area of the first bonding regions 5a in the high elastic laminate part A2. Furthermore, the elastic laminate sheet that is formed can be processed by first temporarily stretching in the lateral direction prior to use, and then allowing to return.

Furthermore, heat needling of the elastic laminate sheet 1, 10 obtained can be performed in order to provide permeability to moisture, and permeability to moisture can also be provided by appropriately perforating the elastic laminate sheet 1, 10.

With an elastic laminate sheet 10 manufactured in this manner, the cracking resistance between the low elastic laminate part A1 and the high elastic laminate part A2 can be enhanced while maintaining the retention to the main body parts when the low elastic laminate part A1 in the elastic laminate sheet 10 or an elastic member cut to an appropriate size therefrom is attached to the main body parts of another hygienic article or the like.

The elastic laminate sheet 1 of the present invention can be used as an elastic member by cutting to a prescribed shape and size. This elastic member should have at least one each of low elastic laminate part A1 and high elastic laminate part A2. Furthermore, in one aspect, the elastic member has a configuration where low elastic laminate parts A1 are provided on both sides of the high elastic laminate part A2. The elastic member can be used for example with clothing such as underwear, a hygienic article such as a disposable diaper (for example, the attached flaps of the mechanical fastener of a disposable diaper), an elastic supporter, or as an ear support for a mask.

Preferred embodiments of the elastic laminate sheet of the present invention and manufacturing method thereof are described above, but the present invention is not restricted to these examples.

### EXAMPLES

The present invention will be explained in further detail below based on working examples and comparative examples, but the present invention is not limited to the following working examples.

### Examples 1-13 and Comparative Examples 1-5

An elastomer film (elastomer layer 3) was manufactured using a film manufacturing apparatus containing a T-die uniaxial melt extruder and a chill roller. The raw material for the elastomer film was a blend of a thermoplastic polyurethane resin elastomer (TPU), styrene-isoprene-styrene block copolymer (SIS), and a hydrogenated petroleum resin (additive). As the TPU, PANDEX (trademark) T-1575X (A hardness 75) manufactured by DIC Bayer was used; as the SIS, a product called Kraton D1117P manufactured by Kraton Polymer Japan was used; and as the additive, a product called Arcon P-125 manufactured by Arakawa Chemical was used. Dry blending was performed using a formulation ratio for TPU:SIS:additive of 88 to 99.2:0.7 to 8.8:0.1 to 3.2, and then the blend was added to a T-die uniaxial melt extruder that had been heated to 200° C. A film-like melted body extruded from the T-die uniaxial melt extruder at conditions where the extruding rotational speed was 20 rpm and the draw speed was 3 mpm was sandwiched on both sides by nonwoven fabric 2, 4 (product name: TPA-032 manufactured by Nan Liu Enterprise) while inserting between a nip roller and a chilled roller that was set to 20° C. The sheet was bonded and hardened by cooling to obtain an elastic laminate sheet 10 with a target thickness of 40 micrometers.

At this time, the elastic laminate sheet 10 was formed using various protruding patterns engraved on the nip roller surface.

In other words, the elastic laminate sheets 10 of examples 1 through 13 and comparative examples 1 through 5 were formed with the first bonding regions 6a in the low elastic laminate part A1 having prescribed shapes classified as follows: type A-1 through A-3, type B, type C, type D, and type E.

Furthermore, the shape of the first bonding regions 5a in the high elastic laminate part A2 were formed with a dot shape having a smaller area than the area of the first bonding regions 6a formed in the low elastic laminate part A1, and elastic laminate sheets 10 were formed according to examples 1 through 13 and comparative examples 1 through 5 such that the area ratio that the first bonding regions 5a account for in the high elastic laminate part A2 is classified by the following types F1 through F5.

The low elastic laminate part A1 were strips parallel to the MD of the elastic laminate sheet, and the width was 30 mm. Furthermore, the high elastic laminate part A2 were also strips parallel to the MD of the elastic laminate sheet, and the width was 40 mm.

The low elastic laminate part A1 and the high elastic laminate part A2 were formed alternatingly along the CD of the elastic laminate sheet.

Note, the elastic laminate sheets obtained according to examples 1 through 13 and comparative examples 1 through 5 were processed by stretching 115% beforehand in the CD and then allowing to return.

### Shape of First Bonding Regions 6a in the Low Elastic Laminate Part A1

Type A-1: The shape of the first bonding regions 6a in the low elastic laminate part A1 was the shape shown in FIG. 2. (However, the length in the MD was 10 mm, the interval between strips was 5 mm, and the area ratio that the first bonding regions 6a occupied in the low elastic laminate part A1 was 67%).

Type A-2: The shape of the first bonding regions 6a in the low elastic laminate part A1 was the shape shown in FIG. 2. (However, the length in the MD was 5 mm, the interval between strips was 5 mm, and the area ratio that the first bonding regions 6a occupied in the low elastic laminate part A1 was 50%).

Type A-3: The shape of the first bonding regions 6a in the low elastic laminate part A1 was the shape shown in FIG. 2. (However, the length in the MD was 5 mm, the interval between strips was 10 mm, and the area ratio that the first bonding regions 6a occupied in the low elastic laminate part A1 was 33%).

Type B: The shape of the first bonding regions 6a in the low elastic laminate part A1 was the shape shown in FIG. 3. (The area ratio that the first bonding regions 6a occupied in the low elastic laminate part A1 was 41%).

Type C: The shape of the first bonding regions 6a in the low elastic laminate part A1 was the shape shown in FIG. 6. (The area ratio that the first bonding regions 6a occupied in the low elastic laminate part A1 was 10.56%).

Type D: The first bonding regions 6a in the low elastic laminate part A1 was the shape shown in FIG. 5. (The area ratio that the first bonding regions 6a occupied in the low elastic laminate part A1 was 10.3%).

Type E: The shape of the first bonding regions 6a in the low elastic laminate part A1 accounted for all of the low elastic laminate part A1. (The area ratio that the first bonding regions 6a occupied in the low elastic laminate part A1 was 100%).

### Shape of First Bonding Regions 5a in the High Elastic Laminate Part A2

Type F-1: The shapes of the first bonding regions 5a in the high elastic laminate part A2 were similar to the shapes shown in FIG. 2 through 6. (However, the area ratio that the first bonding regions 5a occupied in the high elastic laminate part A2 was 0.39%).

Type F-2: The shapes of the first bonding regions 5a in the low elastic laminate part A1 were the shapes shown in FIG. 2 through 6. (However, the area ratio that the first bonding regions 5a occupied in the high elastic laminate part A2 was 0.57%).

Type F-3: The shapes of the first bonding regions 5a in the low elastic laminate part A1 were the shapes shown in FIG. 2 through 6. (However, the area ratio that the first bonding regions 5a occupied in the high elastic laminate part A2 was 0.88%).

Type F-4: The shapes of the first bonding regions 5a in the low elastic laminate part A1 were the shapes shown in FIG. 2 through 6. (However, the area ratio that the first bonding regions 5a occupied in the high elastic laminate part A2 was 1.57%).

The elastic modulus of the high elastic laminate part A2 and the elastic modulus of the low elastic laminate part A1 were measured for the elastic laminate sheets obtained. Furthermore, the ratio of the elastic modulus of the low elastic laminate part A1 to the elastic modulus of the high elastic laminate part A2 ([elastic modulus of low elastic laminate part A1]/[elastic modulus of high elastic laminate part A2]) was calculated from the elasticity values that were measured.

Measurement of Elastic Modulus of High Elastic Laminate Part A2 and Elastic Modulus of Low Elastic Laminate Part A1

The elastic modulus of the low elastic laminate part A1 and elastic modulus of the high elastic laminate part A2 were measured by the following method. The elastic modulus of the low elastic laminate part A1 was determined by first cutting strip shaped samples with a width 10 mm in the longitudinal direction (MD) and a length of 20 mm in the lateral direction (CD) from the low elastic laminate part A1 of the elastic laminate sheets obtained. Next, the sample obtained was fastened to a tensile tester (model RTG-1225 manufactured by Orientec Co., Ltd.) such that the distance between chucks was 15 mm without tension and the CD direction of the sample was in the direction of tension. The test sample was deformed at a rate of 100 mm/minute in the CD direction and the stress strain curve was determined. The elastic modulus was determined from the slope of the section of the stress strain curve obtained where the stress rises in a straight line. The elastic modulus of the high elastic laminate part A2 was measured similarly.

The durability (crack resistance) and the retention force of the elastic laminate sheet obtained were evaluated at the following conditions. The results are shown in Table 1.

### Evaluation of Durability (Crack Resistance)

A sample with a width of 25 mm in the longitudinal direction (MD) and a length of 70 mm in the lateral direction (CD) was cut from the elastic laminate sheet. At this time, the regions 15 mm from both ends in the CD parts were made into the low elastic laminate part A1. The cut sample was fastened into a tensile tester (model RTG-1225 manufactured by Orientec) where the chuck distance was set to 50 mm, a test was performed by repeating a cycle of stretching in the CD to 10 N at a test speed of 1000 mm/minute, and the number of cycles until the elastomer layer breaks was recorded.

### Evaluation of Retention Force

Spunbond nonwoven fabric (SB02, manufactured by Unitika) was cut to a 50 mm square. The cut nonwoven fabric was folded in half, and one end in the CD direction of a an elastic laminate sheet sample cut to a width of 25 mm in the longitudinal direction (MD) and a length of 70 mm in the lateral direction (CD) was sandwiched between the nonwoven fabric that was folded in half. Note, the elastic laminate sheet sample is manufactured with low elastic laminate parts A1 that are 15 mm from each end in the CD direction, and 40 mm high elastic laminate part A2 is formed between the low elastic laminate parts A1 at both ends. When the elastic laminate sheet sample is sandwiched between the nonwoven fabric that was folded in half, the nonwoven fabric ends overlap with the interface between the high elastic laminate part A2 and the low elastic laminate part A1 of the elastic laminate sheet sample, and the nonwoven fabric and the elastic laminate sheet sample are heat sealed at a position on the low elastic laminate part A1 that is 5 mm from the interface using a Clip Sealer Z-1 (manufactured by Techno Impulse).

The aforementioned heat sealed samples are attached to a tensile tester (model RTG-1225, manufactured by Orientec) where the chuck distance was set to 65 mm. Note, when attaching the sample, the top side was attached by clamping only the nonwoven fabric portion, and the bottom side was attached by clamping only the low elastic laminate part A1 portion (where the nonwoven fabric is not present). After attaching, the sample was pulled at a rate of 300 mm/min.

When the sample broke, the retention force was given the evaluation “PASS,” and when separation from the nonwoven fabric occurred prior to the sample breaking, the retention force was given the evaluation “FAIL.”

TABLE 1

| | Shape of bonding | Shape of bonding | | Durability | |
|---|---|---|---|---|---|
| | parts in the low | parts in the high | | Number of | Retention |
| | elastic laminate | elastic laminate | | cycles until | force |
| | part | part | Elasticity ratio | breaking | Judgment |
| EXAMPLE 1 | Type A-1 | Type F-2 | 7.3 | 28 | PASS |
| EXAMPLE 2 | Type A-1 | Type F-3 | 7.1 | 29 | PASS |
| EXAMPLE 3 | Type A-2 | Type F-3 | 5.6 | 50 | PASS |
| EXAMPLE 4 | Type A-2 | Type F-1 | 6.2 | 34 | PASS |
| EXAMPLE 5 | Type A-3 | Type F-3 | 4.0 | 50 | PASS |
| EXAMPLE 6 | Type B | Type F-4 | 2.9 | 50 | PASS |
| EXAMPLE 7 | Type B | Type F-3 | 3.7 | 38 | PASS |
| EXAMPLE 8 | Type B | Type F-1 | 4.1 | 32 | PASS |
| EXAMPLE 9 | Type C | Type F-3 | 3.0 | 50 | PASS |
| EXAMPLE | Type C | Type F-1 | 3.3 | 37 | PASS |
| 10 | | | | | |
| EXAMPLE | Type D | Type F-4 | 1.7 | 50 | PASS |
| 11 | | | | | |
| EXAMPLE | Type D | Type F-3 | 2.1 | 39 | PASS |
| 12 | | | | | |
| EXAMPLE | Type D | Type F-1 | 2.4 | 43 | PASS |
| 13 | | | | | |
| Comparative | Type F-1 | Type F-1 | 1.0 | 30 | FAIL |
| Example 1 | | | | | |
| Comparative | Type E | Type F-1 | 10.6 | 16 | PASS |
| example 2 | | | | | |
| Comparative | Type E | Type F-3 | 9.6 | 17 | PASS |
| Example 3 | | | | | |
| Comparative | Type E | Type F-4 | 7.7 | 18 | PASS |
| Example 4 | | | | | |
| Comparative | Type A-1 | Type F-1 | 7.9 | 20 | PASS |
| Example 5 | | | | | |

In examples 1 to 13, the first bonding regions 6a and the first bonding regions 5a are provided such that the ratio between the elastic modulus of the high elastic laminate part A2 and the elastic modulus of the low elastic laminate part A1 is within a specific range, and therefore, the number of cycles until breaking is higher and the durability (crack resistance) is clearly superior compared to the comparative examples 1 through 5.

1. An elastic laminate sheet comprising a laminate comprising an elastomer layer and a nonwoven fabric provided on at least one surface of the elastomer layer, wherein
a low elastic laminate part and a high elastic laminate part are alternatingly provided in one direction to form the laminate;
the low elastic laminate part and the high elastic laminate part both have a first bonding region where the elastomer layer and the nonwoven fabric are bonded and a second bonding region where the elastomer layer and the nonwoven fabric are bonded more weakly than at the first bonding region;
a total surface area of the first bonding region in the low elastic laminate part is larger than a total surface area of the first bonding region in the high elastic laminate part; and
a ratio of an elastic modulus of the low elastic laminate part to an elastic modulus of the high elastic laminate part is more than 1 and not more than 7.5.

2. The elastic laminate sheet according to claim 1, comprising a laminate containing an elastomer layer and a nonwoven fabric provided on both surfaces of the elastomer material.

3. An article comprising the elastic laminate sheet according to claim 1.
